(19) United States
(12) Patent Application Publication
(10) Pub. No.: US 2007/0152047 A1
(43) Pub. Date: Jul. 5, 2007

(54) PRODUCT MANAGING SYSTEM AND METHOD USING RFID TECHNOLOGY

(75) Inventors: Mengru (Arthur) Tu, Taoyuan County (TW); Jen-Yau Kuo, Hsinchu City (TW); Kuo-Shu Lo, Hsinchu City (TW); Cheng-Wei Huang, Taipei County (TW); Li-Dien Fu, Kingmen County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/463,009

(22) Filed: Aug. 8, 2006

(30) Foreign Application Priority Data
Dec. 30, 2005 (TW) 94147523

(51) Int. Cl. G06Q 30/00; G08B 13/14

(52) U.S. Cl. 235/385; 340/572.1; 705/28

(57) ABSTRACT

A product managing system and method using RFID technology is provided. The product managing system includes an RFID tag, an RFID reader, and a server. The RFID tag is set on a product for providing a tag ID, an object type and attribute, and an event content. The RFID reader reads the RFID tag. The server obtains various information provided by the RFID tag set on the product from the RFID reader, determines the product ID according to the tag ID, determines a class of the product and whether the product is correctly combined with another product according to the object type and attribute, and determines whether a processing procedure of the product is correctly conducted according to the event content. The server finally determines whether the product is normal according to the aforementioned determinations.

### CROSS-REFERENCE TO RELATED APPLICATION

This application claims the priority benefit of Taiwan application serial no. 94147523, filed Dec. 30, 2005. All disclosure of the Taiwan application is incorporated herein by reference.

### BACKGROUND OF THE INVENTION

1. Field of Invention

The present invention relates to an RFID application system, and more particularly, to a product managing system and method using RFID technology.

2. Description of Related Art

Currently, enterprises communication between associated business processes of individual departments is based on basic identification tools (e.g., a barcode system) and their generated identification codes in daily management of operation. However, these identification tools have been developed to their utilization limit and encountered bottlenecks after their long term development and application. Taking the barcode system as an example, its cost cannot be reduced, and the contact reading mode thereof causes many inevitable human mistakes, which thus contributes to a operation flow risk of enterprises, or becomes a weakest link in a supply chain of enterprises. Therefore, it can be seen that a new basic identification tool and associated techniques for supporting this new technology become an important project that enterprises must invest for the future. The Radio Frequency Identification (RFID) application system is a representative of this new technology.

Basically, an RFID chip is a high-tech barcode capable of scanning a contained article by a distance, even separated by a box or a packing container. Supporters believe that “RFID technology is the key for significantly promoting supply chain's efficiency”. At present, the cost of RFID is still too high, and also its feasibility has not been verified, however, Wal-Mart and the US Department of Defense have instructed suppliers to start to adopt this technology. It is generally agreed that, with the positive promotion of these two crucial institutions, the popularization and realization of RFID application are to be hopefully and significantly promoted. RFID has become widely applied, and it is now typically applied to animal chips, car chip alarms, access control, parking lot management, production line automation, material management, and the like. In industrial application, RFID has an obvious effect in a retailing stock control and the cost reduction of the supply chain, which reduces the managing cost and promotes the dispatching flexibility of stock goods, and also RFID technology may be used to trace the flow of goods from fabrication to large-scale distributors.

At present, several techniques using RFID have been provided, such as U.S. Pat. No. 6,847,856 “Method for determining juxtaposition of physical components with use of RFID tags”, and U.S. Patent Application No. US2004100384 “RFID system and method for ensuring personnel safety”. These techniques apply RFID to component assembly and automatic identification of the automatic production system, and achieve information integration for a single system, but lacks technical support in the respect of how to efficiently manage information to achieve the product management.

### SUMMARY OF THE INVENTION

The present invention provides a product managing system and method using RFID technology, which is applicable in an information system with a flexible, agile production control, and has a complete and flexible data model design to integrate the RFID technology with enterprise information.

The present invention provides a product managing system using RFID technology, which comprises an RFID tag, an RFID reader, and a server. The RFID tag is set on the product to provide a tag ID, an object type and attribute, and an event content. The RFID reader is used to read the RFID tag. The server obtains various information provided by the RFID tag set on the product from the RFID reader, determines the product ID according to the tag ID, determines a class of the product and whether the product is correctly combined with another product according to the object type and attribute, and determines whether the processing procedure of the product is correctly conducted according to the event content. Finally, the server determines whether the product is normal according to the aforementioned determinations.

The present invention provides a product managing method using RFID technology. The RFID tag is used to provide a tag ID, an object type and attribute, and an event content. Then, the tag ID is read to determine the product ID of the product; the object type and attribute are read to determine a class of the product and whether the product is correctly combined with another product; and the event content is read to determine whether a processing procedure of the product is correct. Finally, the product managing method determines whether the product disposed with the RFID tag is normal according to the aforementioned determinations.

According to above description, as the present invention adopts an RFID tag with a flexibly adjustable content to trace each feature of the product, and is further accommodated with the cooperation between each agent module, the present invention is applicable in an information system of a flexible, agile production control. Also, the present invention has a complete and flexible data model design, so as to integrate the RFID technology with enterprise information.

In order to the male aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a systematic block diagram of a product managing system using RFID technology according to an embodiment of the present invention.

FIG. 2 is schematic view of the contents of the RFID tag used in the product managing system according to an embodiment of the present invention.

FIG. 3 is a schematic view of each module used in initializing the mobile agent and the operation relationships thereof according to an embodiment of the present invention.

FIG. 4 is a schematic view of each module used during the operation of the mobile agent and the operation relationships thereof according to an embodiment of the present invention.

### DESCRIPTION OF EMBODIMENTS

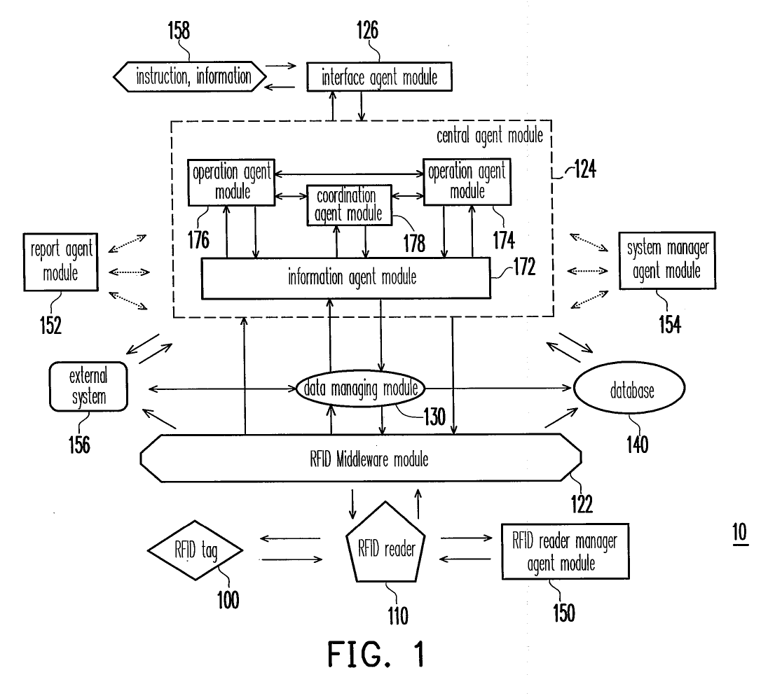

Referring to FIG. 1, it is a systematic block diagram of a product managing system using RFID technology according to an embodiment of the present invention. As shown, the product managing system 10 comprises a Radio Frequency Identification (RFID) tag 100, an RFID reader 110, an RFID Middleware module 122, a central agent module 124, an interface agent module 126, a data managing module 130, and a database 140. The database 140 is used to store initializing data, main data, static information, dynamic information, RFID tag path information, process-associated information, and data of an external system to be processed. Moreover, the data managing module 130 is coupled to the database 140, the external system 156, and the server (at least including the RFID Middleware module 122 and the information agent module 172), so as to access the data of the database 140, and convert data format between the database 140, the external system 156, and the server.

The RFID tag 100 is set on the product (or referred to as a mobile agent) to provide a tag ID, an object type and attribute, and an event content. The RFID reader 110 is used to read the RFID tag 100, and is also provided with a function of writing the data into the RFID tag 100. Generally speaking, the RFID tag 100 is an active RFID tag or a passive RFID tag, and the RFID reader 110 is classified into an agent module starter/body, an agent module locator, and a gate watcher according to the usage mode. The agent module starter/body is mainly used as a starter and a writing body of the RFID tag 100, and allows only one RFID tag 100 to enter its identifying range at a time. The agent module locator is mainly used in, for example, a handheld RFID reader to search a specific RFID tag, and also allows only one RFID tag 100 to enter its identifying range at a time. The gate watcher is mainly used at the gate or warehouse entrance/exit to perform a mass scanning, and allows a plurality of RFID tags 100 to enter its identifying range at a time. Moreover, an RFID reader manager agent module 150 assists to control the setting, monitor, error-exclusion, and other operations of the RFID reader 110.

Furthermore, in the embodiment, the RFID Middleware module 122, the central agent module 124, and the interface agent module 126 are components of the server. Thus, the server obtains various information provided by the RFID tag 100 set on the product from the RFID reader 110, and determines a product ID of the product according to the tag ID, determines a class of the product and whether the product is correctly combined with another product according to the object type and attribute, and determines whether a processing procedure of the product is correct according to the event content. Finally, the server determines whether the product is normal according to the aforementioned determinations. To achieve the above functions, the RFID Middleware module 122 obtains the aforementioned tag ID, the object type and attribute, and event content from the RFID reader 100, and the data are further sent to the central agent module 124, so as to determine a processing procedure to be executed according to the data. Moreover, the interface agent module 126 receives an external instruction and transmits the external instruction to the central agent module 124 so as to perform a corresponding process.

Furthermore, the central agent module 124 generally comprises an information agent module 172, more than one operation agent modules 174, 176, and a coordination agent module 178. The information agent module 172 accesses the database 140 through the data managing module 130, or directly accesses the database 140, so as to provide a function of accessing the aforementioned data or a continuously monitoring the data source. The operation agent module 174 or 176 is coupled to the interface agent module 126 and the information agent module 172, receives an external instruction from the interface agent module 126 and executes a specific processing procedure, and obtains the required data through the information agent module 172. The coordination agent module 178 is used to coordinate and manage the interaction between individual agents and continuously monitor the operations of individual agent modules. Moreover, to provide a more perfect function, a report agent module 152 is added outside the central agent module 124 to process the affairs associated with information output, or a system manager agent module 154 is used to manage the generation or extinction of each agent module.

The aforementioned individual agent modules are generally classified into logical agent modules and physical agent modules. The logical agent module represents a virtual or conceptual object, such as the interface agent module 126, the operation agent modules 174 and 176, the information agent module 172, and the coordination agent module 178. The physical agent module represents a physical static existing object, such as the RFID reader manager agent module 150 or an RFID tag handler agent module for managing the RFID tag 100 (to be described in detail below) of the embodiment.

The logical agent modules are introduced in detail below. In an embodiment of the present invention, the operation agent module receives an instruction from the interface agent module 126 and performs a specific task or processes a specific business logic. The operation agent module 174 and the operation agent module 176 may communicate, cooperate, and share messages with each other, and obtain the required information through the information agent module 172. In each operation agent module, it comprises the following agent modules.

1. Master Data Manager Agent module (containing one data accessor agent): mainly for processing master data, data initialization, and other associated requirements.

2. Session Manager Agent module (containing one data accessor agent): for receiving parameters from the RFID tag Handler agent module (to be described in detail below); obtaining associated information of a certain RFID tag from the database of the agent memory or the agent recipe according to the parameters and transmitting them back to the tag handler agent so as to perform a further determination and process. Moreover, it is responsible for communicating with the RFID tag handler agent, an event manager agent module (to be described in detail below), and a service manager agent module (to be described in detail below), and accessing the data of the agent memory and activity tag data. Also, The Session Manager Agent module is responsible for accessing all information content of interactions associated to the RFID tag. The Session Manager module also provides data cache service for sets of parameter data accepted from a Tag Handler Agent instance and location and/or operation specific information retrieved from Session Data (requested by the same Tag Handler Agent). When an RFID event processing cycle (initiated by Tag Handler Agent) is completed, it synchronizes the processing information with Session Data and releases memory resource in a computer server. This caching and RFID event session cycle management service provided by Session Manger Agent help improve the overall RFID event processing speed and data integrity.

3. Service Manager Agent module: responsible for receiving an event processing notification from the RFID tag handler agent, communicating with session manager, and directing a tag event to corresponding services. The service manager agent selects associated services to process a RFID tag (i.e., a corresponding mobile agent) event, transmitting associated information and initiating corresponding services. When the invoked external services completed, the service processing information is sent back to the Service Manager Agent by the external services (directly or through the network service and SOA architecture). Service Manager Agent then relays service processing information to the Session Manager Agent.

4. Event Manager Agent Module (containing one data accessor agent): for providing a function of accessing the data of the agent recipe, and making a write or clear instruction for the data of the RFID tag through the RFID tag handler agent; receiving the data and instruction from the session manager agent, correctly preparing the information required by the new event and producing a new event code, and requesting the RFID tag handler agent to write the correct associated event information into the corresponding RFID tag. Moreover, it is capable of the change of a real-time dynamic flow: receiving an instruction from the external system, and for the product of a certain model, or the processed object on a certain workstation (i.e. the aforementioned mobile agent), directly changing the associated parameters in the event content thereof (writing the associated parameters into the RFID tag of the mobile agent through the RFID tag handler agent), so as to change the business or operational flow of the next step. Furthermore, the advanced function of the agent module is a computing capability for a best production route (path): determining (through a data comparison and computing) the next processing path of the mobile agent (e.g., selecting a workstation which is idle or has a shorter waiting time from a connatural workstation group) according to the latest information of the usage state (fully loaded or idle) of the workstation (RFID Station) of the agent recipe database and the agent memory (reading the associated information from the agent memory through the session manager agent). Accordingly, the whole production flow is changed to a dynamically changing and non-predefined real-time dynamic determination manner from the conventional predefined manner. This dynamic production/manufacturing flow is able to not only greatly increase the production efficiency and capacity utilization of equipments in the production line, but also significantly enhance flexible dispatching of enterprise production resources and emergency handling capability.

5. Access Control Agent module: mainly for providing functions such as system associated settings, user privilege management, and user security authorization.

6. Order Manager Agent Module (containing one data accessor agent): for providing a basic order schedule trace.

7. User Event Handling Agent (containing one data accessor agent): providing real-time synchronous event handling processes for internal and external users of the system.

8. Production Event Response Agent module: for providing a real-time track and trace of WIP (work in process) and work orders; providing a real-time production yield monitor. It continuously monitors and detects whether or not there is any abnormality in the information associated with the production/manufacturing. If any abnormal signal (e.g., a lower yield of a certain workstation) occurs, it reports to the upper associated interface agent module instantly.

9. Inventory Event Response Agent module: for providing a real-time track and trace of the stock, component, and material, and continually monitoring and detecting whether or not there is any abnormality in the information associated with the stock. If any abnormal signal occurs (e.g., a stock gap (shortage) on a certain main component occurs), it reports to the upper associated interface agent module instantly.

10. Enterprise Report Engine (containing one data accessor agent): for providing various real-time associated customized enterprise reports.

Furthermore, the information agent module 172 is used to provide a data access function and continuously monitor to the data source. In an embodiment of the present invention, the product managing system 10 is provided with the following information agent modules.

1. Production Sensor Agent module: access and monitor of data associated with production.

2. Inventory Sensor Agent module: access and monitor of data associated with inventory.

3. Security Sensor Agent module: access of data associated with security.

4. RFID Activity Monitor Agent module: access and monitor of the data associated with RFID activity path.

5. Data Accessor Agent module: a generic data accessor agent module, which could be contained in various logical agents, such that these logical agents can access the database directly.

Moreover, the coordination agent module 178 is responsible for coordinating and managing the interaction between individual agent modules, and continuously monitoring the activities of the agent modules. For example, it is responsible for managing the register of a new agent module and the suspension and cancellation of the old agent module, and detecting the connection state and other states of active agent modules. This system is provided with a team mediator agent (containing one data accessor agent) so as to achieve the above functions.

Then, the physical agent modules are described in detail. In an embodiment of the present invention, an RFID tag handler agent is provided to read and write the associated information with the tag through the help of RFID Middleware module, accept any RFID tag entering the region, analyze a tag ID string and transmit associated parameters (information such as tag ID, ID type, and event ID) to the session manager agent. The session manager agent obtains the associated information with a certain mobile agent from the databases of the agent memory or the agent recipe by using the parameters, and sends them back to the RFID tag handler agent so as to perform a further determination and process. Then, the RFID tag handler agent compares the analyzed tag ID parameter with the associated parameters provided by the session manager agent, so as to determine whether the event represented by the RFID tag can be processed at this location/workstation and at this time. Moreover, the RFID tag handler agent also processes the event information (event header and event payload) recorded in the event ID in the tag, and analyzes the event content and triggers associated operational flow. Furthermore, the RFID tag handler agent is also used to process the associated operational flow of the workstation having an RFID reader. Usually, one or one group of physical RFID readers belonging to the same station in logic corresponds to an RFID tag handler agent. The station is a workstation, a classification station for semi-manufactured or manufactured products, a gate of workshop or warehouse, and the like. The two cases that the RFID station is used as a workstation and a classification station/gate are discussed below.

(A) When the station is used as a workstation, besides that pure RFID tag path information (information such as tag ID, reader ID, and time) are directly written to the database of the tag activity, all the information about the RFID station are stored in the exclusive tables of the agent memory database. The data tables mainly include static information and dynamic information, and the detailed illustration is mentioned below.

(B) When the station is a classification station/gate, besides that a part of the information must be written into the agent memory database after a complicated process in special cases (e.g., exceptional cases of sending information to an incorrect location, passing a gate which should not be passed), the RFID gate mostly only captures the RFID tag path information (e.g. information such as tag ID, reader ID, and time), and directly writes it in the database of the tag activity without performing a further complicated process.

Moreover, those modules such as the RFID reader manager agent module 150 and the RFID Middleware module 122 also belong to the physical agent module, and the modules perform a setting, monitor, error-exclusion, and other management functions to a plurality of RFID readers.

In design, the logic agent module and the physical agent module are respectively configured in a central system or a local system. Usually, the smallest unit of the local system is a workstation, and the largest unit is a production line. Physically, a PC server or a computer workstation is configured for a workstation or a production line, and a set of agents (mainly including an RFID tag handler agent, a session manager agent, and a service manager agent) are set according to the workstation property and an RFID Middleware software (which is a purchased software) corresponding to each workstation. The agents and RFID Middleware software programs are stored in the PC server or the computer workstation. The RFID tag handler agent communicates with the central system (e.g., accesses the data) through the session manager agent, and interacts with an external system (e.g., an equipment system), transmits associated instructions and receives the information sent back by the external system through the service manager agent. Usually, the smallest unit of the central system is a factory/workshop operating separately, and the largest unit is a whole enterprise. Physically, one or more large-scale enterprise servers are configured, which include an application server system (generally including the aforementioned server) and a database system (including the aforementioned data managing module 130 and the database 140). Besides the agent modules configured in the local system, most agent modules are configured in the central system to facilitate the management and maintenance.

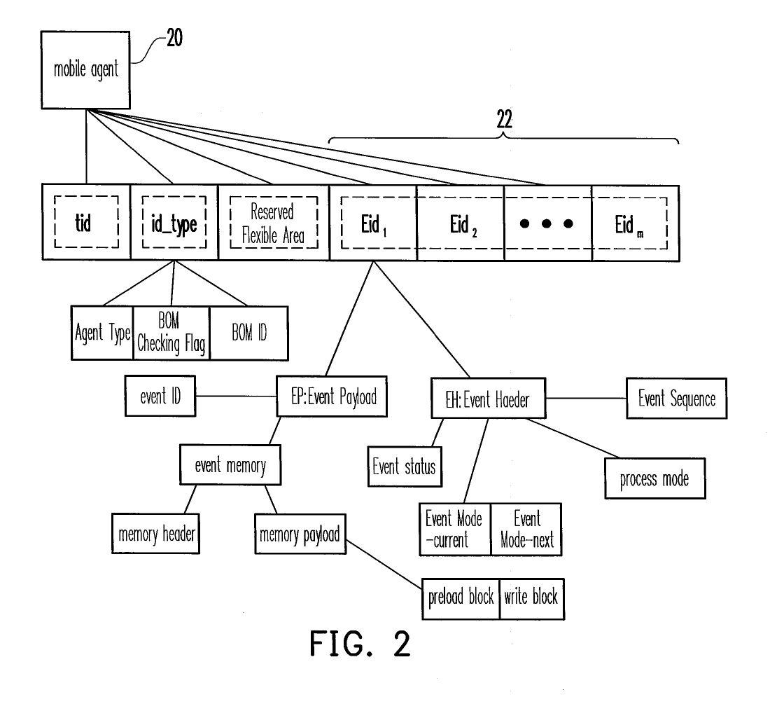

Referring to FIG. 2, it is a schematic view of the contents of a RFID tag used in the product managing system according to an embodiment of the present invention. In the embodiment, the RFID tag as a mobile agent provides a tag ID (tid), object type and attribute (id_type), and an event content denoted as Eid. The object type and attribute comprises an agent type for providing a product category, a BOM Checking Flag for marking whether the product is combined with another product, and a BOM ID for marking a product ID of another product combined with the product. Furthermore, the event recording area (Eid1˜Eidm) comprises at least one event content (Eid), and each event content includes an event payload (EP) for recording the event ID of the event and providing a storage space of various setting data, and an event header (EH) for recording process sequence, process result, process mode of the event and the determination manners of the event and the next event.

Generally speaking, the mobile agent is defined as one among material lot, key component, and main product. Furthermore, the memory data structure in the mobile agent 20 is also designed specially in the present invention. The product information or other key information is loaded in the memory unit in the chip of the RFID tag, such that it becomes a mobile agent 20. The data of the memory unit is read by the RFID reader, and may also be written/changed or cleared by the RFID reader. As described above, the memory data structure in the mobile agent 20 is divided into three parts, namely, the tag ID (tid), the object type and attribute (id_type), and the event content.

As shown in FIG. 2, the tag ID tid is a unique code of the RFID tag, for representing a physical object, and the coding manner thereof follows an industry standard (e.g. EPC Global or ISO standards) or is defined by the company.

The object type and attribute id_type is used to represent the type of the physical object and its attribute. For example, during the production, the tag represents whether the physical object is of a component type or a final product type.

The agent type facilitates a quick classification of the physical objects at the front end, and is divided into three parts, namely, the material lot, the key component, and the main product. Of course, except the above three main agent types, the user can define other agent types. If accommodating the associated setting of the RFID tag handler agent, the data structure design established in the memory of the mobile agent 20 provides the enterprise with many flexible application manners. For example, a certain RFID tag handler agent is set to only read the RFID tag marked as P (main product) in the agent type, and therefore, if a work piece of a certain main product is added with a key component attached with another RFID tag (having the object type and attribute C) other than its own PFID tag, the RFID tag handler agent only reads the RFID tag information of the main product and starts a associated processing procedure, and ignores or separately processes the RFID tag information of the key component. A different example for the application of agent type is to set a agent type as carrier (for example, a tray or pallet) which carries more than one tagged main products or components and the mapping information regarding the relationship between the carrier and its associated carrying items can be registered in the Event Payload or central system. When a agent type is about to change, each event content correlated with previous agent type must be updated with its corresponding agent type information in the memory payload of each event content. Finally, as agent type changed, its corresponding BOM_ID may subject to change as well.

The BOM Checking Flag is used to mark whether the product is combined with another product. When the RFID reader of a certain workstation requires to read the RFID tags of the main product, the key component, or even the material lot simultaneously so as to determine whether the main product is combined with a correct component or used with a correct material quantity, the BOM Checking Flag of the RFID tag on the main product is set as Y, and otherwise, it is set as N. When the RFID tag on the main product is set as Y, no matter the BOM Checking Flag of the RFID tag of the key component or the material lot read subsequently is set as Y or N, the RFID tag handler agent of the system obtains associated BOM information from the system database (Agent Recipe) according to the BOM (Bill of Material) ID of the main product, key component, or material lot, and performs a comparison to determine whether the main product is combined with a correct component or used with a correct material quantity.

In other words, the BOM Checking Flag is considered as a mistake-proof or a fool-proof design on the product assembly. Furthermore, the code of the BOM ID must be predefined by the enterprise and be written in during the initialization of the mobile agent.

Associated information about the event content is introduced below. As shown, the event recording area 22 includes more than one event contents (Eid1, Eid2, etc.). Taking the event content Eid1 as an example, each event content comprises an event header EH and an event payload EP. The event header is used to record the process sequence, process result, and process mode of the event, and the determination manners of the event and the next event. The event payload is used to record the event ID of this event and provide a storage space of various setting data. The event header and the event payload are described in detail respectively below.

In the event header EH, the process sequence denoted by Event Sequence, can be represented by any numbering scheme. The process result, denoted by Event Status, can be set to record the status information regarding event process result such as Complete/Not-Complete or Success/Fail. The Event Mode and the determination manners of the current event and the next event are particularly introduced in the following discussion. The Event Mode mainly comprises an Event Mode-Current and an Event Mode-Next. The Event Mode is mainly defined as the following two manners: Dynamic (DY) and Predefined (PD). The detailed description is as follows.

If the event is determined dynamically, the system compares the associated parameters in the database (agent memory and agent recipe) according to the Event ID, so as to determine whether the event represented by the mobile agent is processed at this workstation, and determine whether the process sequence of the event is correct. Finally, the system compares the associated parameters through the event manager agent, so as to determine the path of the next workstation, produce a new event information (including id_type and event content) and write it into the mobile agent through the RFID tag handler agent.

If the event is predetermined, when the mobile agent is initialized, the system produces and writes all event contents into the mobile agent through the event manager agent in advance. Therefore, when the mobile agent enters a certain workstation to be processed, the system (local system-local RFID tag handler agent, service manager agent) performs the process directly without communicating with the central system and performing a series of determinations. Therefore, although the manner of predetermined the event process mode reduce some benefits of flexible and agile production, it accelerates the producing speed and achieves an offline production functionality.

Moreover, the Eevent Process Mode may be recorded in the event header to represent a process mode of a certain mobile agent. Generally speaking, the process mode is classified into a unit process (UP) and a batch process (BP). Taking the agent type in the object type and attribute (id_type) as a reference, if the agent type is P (main product) and the process mode is set as UP, the RFID tag handler agent of the system only processes a mobile agent at a time. At this time, if another RFID tag of a mobile agent with an agent type being P (main product) is read, an alarm is sent and the process stops. Similarly, when the agent type is C (key component) or B (material lot), the process manner is similar.

Furthermore, if an agent type of a certain mobile agent is P (main product), and its process mode is set as BP, it is processed by the RFID tag handler of the system together with other mobile agents of a same rank (e.g., of a same agent type of P). At this time, the RFID tag handler agent usually corresponds to the RFID reader or the reader group constructed on the gate physically, and the RFID tag handler agent is set to directly record the tag activity path into the data table of tag activity data of the database of this system through the session manager agent without processing the event content. Usually, after the mobile agent is processed and before the mobile agent is stored, the system sets the next event (i.e., the storage action) process mode as BP, so as to facilitate batch processing and accelerate system processing speed.

It should be noted that when the process mode is set as BP, the event mode must be set as PD automatically.

The event payload mainly comprises the following elements: a unique event identification number and an event storage space. Each element-encoding manner is defined by the user. The event identification number is an identification code of the event recorded in the mobile agent, and usually includes an agent state stage code predefined by the system (such as production, testing, and storage codes, determined by the user) and a location ID (such as workstation or warehouse code).

The storage space mainly comprises a memory header and a memory payload. The memory header activates the storage space only when a storage-permit flag is turned on, and then the data is written as a memory payload. If the storage-permit flag is not turned on, the data is not allowed to be written in.

The memory payload is divided into a preload block and a write block. When the mobile agent is initialized, a certain setting data and work instructions associated with the mobile agent or the workstation are preloaded into the preload block of the memory payload of each new added event through the event manager agent by the system in advance. Then, when passing through each workstation, the information in the preload block is directly read by the tag handler agent and the service manager agent configured in the local system, and a process is performed directly without any interaction with the central system. The associated information produced during the production is registered in the write block and not stored in the database of the central system. The data in the write block is written into the database (agent memory) of the central system at a suitable time, so as to ensure data synchronization.

With the aforementioned practice, the mobile agent is provided with identities of mobile and distributed databases, and is applicable for the production manner of the distributed/offline production and accelerating the producing speed, that is, when the central control system crashes, the whole production line operates normally (as long as the local system operates normally).

Furthermore, to reserve a flexible application space, in addition to the aforementioned various information storage spaces, some reserved space may be kept, such that the customer may define other contents by themselves or expand associated functions.

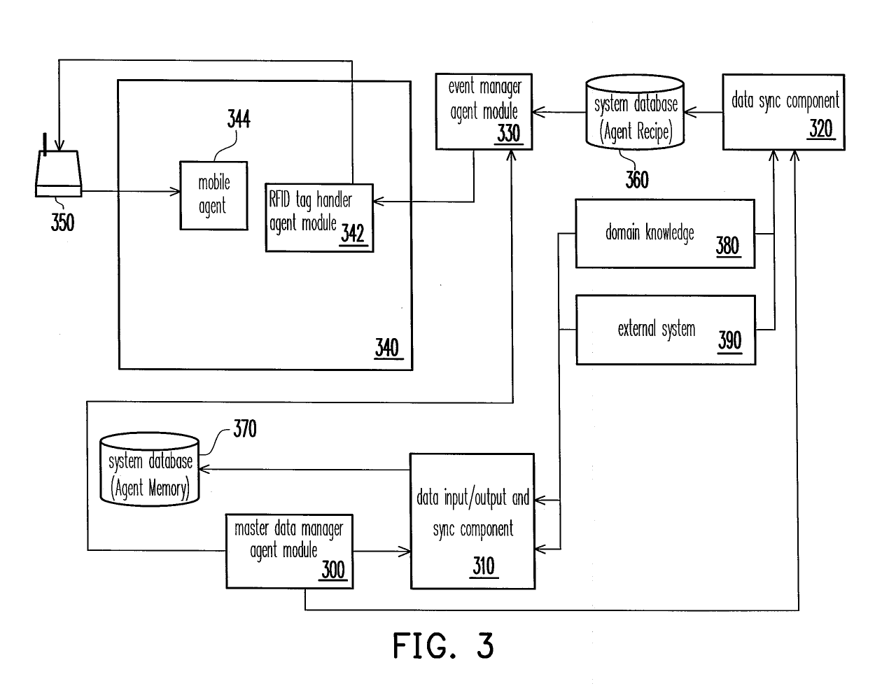

After the data architecture of the mobile agent and the associated system are introduced, then the initialization manner of the mobile agent is further illustrated. Referring to FIG. 3, it is a schematic view of each module used in initializing the mobile agent and an operation relationship thereof according to an embodiment of the present invention.

FIG. 3 is a schematic view of each module used in initializing the mobile agent and the operation relationships thereof according to an embodiment of the present invention. Referring to FIG. 3, the so-called RFID tag information initialization is aimed to clear the RFID tag which is new or capable of being used repeatedly, and to provide a new product (mobile agent) with a new code (Tag ID) and event information. The product is represented by the new code from beginning to the end of the production. In the initialization, the mobile agent 344 is placed in the initialization station 340 at first. The ETL (Extraction, Transformation, and Loading) program is activated by the master data manager agent module 300, thereby obtaining the initial data in a domain knowledge base 380 or an external system 390 by the data input/output and a sync component 310. The associated ETL program processes and stores the initial data into an associated data table of a system database (agent memory) 370 and a system database (agent recipe) 360 (by the data input/output and the sync component 310 or the data sync component 320 respectively).

After the initial data are obtained, the master data manager agent module 300 transmits the tag (Tag ID) data to be initialized to the event manager agent module 330 and announces its destination. Through the information of the system database (agent recipe) 360, the event manager agent module 330 obtains the initial associated data of the tag (or the mobile agent), including the aforementioned tag ID, id_type, and associated parameters with each event.

At this time, the event manager agent module 330 predefines each event and the whole event linklist. The event modes of the individual events are classified into the two following process manners (the following steps are repeated until the event adding is finished).

1. The event mode is Predefined (PD): the current event mode of a certain new added event is set as PD, the memory header of the new added event is set as ON, and some setting data and work instructions associated with the mobile agent 344 or each workstation are preloaded in a preload block in the memory payload of the new added event. Finally, the event mode of the next event following the event is written into a block of the next event mode of the new added event.

2. The event mode is Dynamic (DY): the current event mode of a certain new added event is set as DY, and as the event parameters are determined dynamically, the uncertain parameter values are set as blank fields, and the parameters are written into the reserved blank fields one by one by the event manager agent module 330 through the RFID tag handler agent 342 when the parameters are determined. Finally, the event mode of the next event following the event is written into a block of the next event mode of the new added event.

The aforementioned process manners are based on an assumption that a PD manner and a DY manner coexist in all events of the mobile agent 344 as mentioned above. If all events of the mobile agent 344 are DY, the event manager agent module 330 only need to prepare the initial event content, and the subsequent event content is produced dynamically according to live situation. If all events are PD, all event contents must be produced in advance.

When the above data are produced, the RFID tag handler agent module 342 informs and transmits the tag ID, the id_type, and the event content to the RFID reader 350, and the RFID reader 350 writes each received data into the memory unit (private memory bank) of the mobile agent 344.

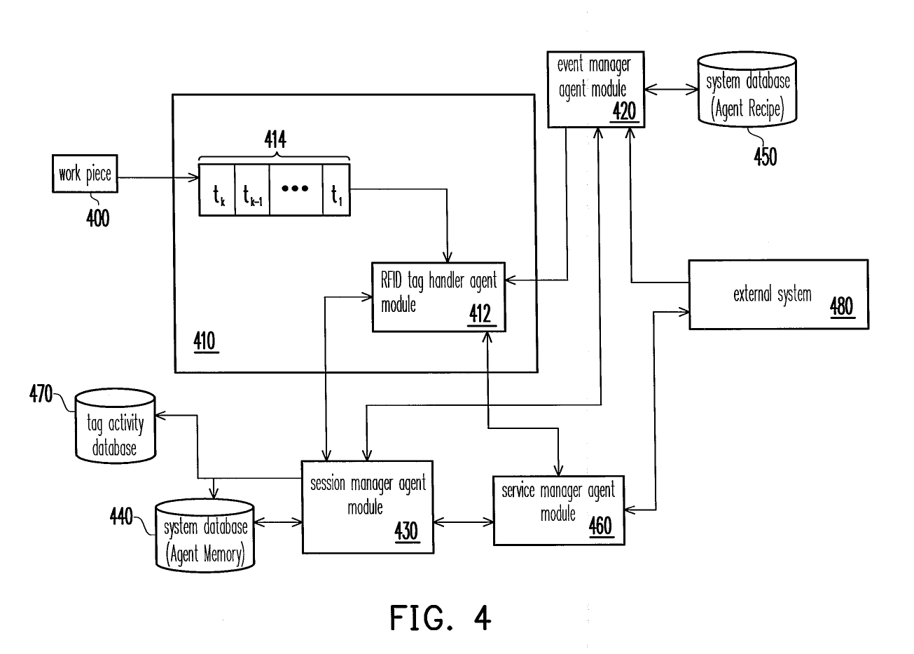

Then, the interaction relationship between the mobile agent and the system during the operation is introduced briefly. Referring to FIG. 4, it is a schematic view of each module used by the mobile agent during the production and the operation relationship thereof according to an embodiment of the present invention.

Generally speaking, RFID information process flow mainly refers to extracting, filtering, synchronizing, and analyzing a great amount of RFID tag information. In FIG. 4, there shows an operation architecture composed by the interactions between each agent module, database, and other associated components of the system. In this operation architecture, a situation of in situ production flow control is adopted, and a series of information process flows generated after a work piece 400 attached with a RFID tag (a mobile agent) enters a workstation (RFID Station) 410, equipped with RFID reader/reader group,

In this embodiment, after the work piece 400 attached with an RFID tag enters a certain workstation or classification station/gate 410, the RFID tag is activated by the RFID reader and its data processed by the RFID tag handler agent 412 located at back-end (if a plurality of work pieces entering the range of the RFID reader, the tag IDs are registered in a tag queue 414 in the RFID tag handler agent module 412 and processed sequentially). When processing each work piece 400, the RFID tag handler agent module 412 will analyze the tag ID, and transmit the associated parameters (such as tag ID, id_type, and event content) to the session manager agent module 430.

The session manager agent module 430 receives the parameters form the RFID tag handler agent module 412, and then obtains the associated information with the work piece 400 to be processed and the workstation 410 from the system database (agent memory) 440 by using the parameters just passed from tag handler agent and caches these data in its memory. The session manager agent sends key parameters regarding a certain mobile agent back to the RFID tag handler agent module 412 (if the event mode of the event is Predefined, this step is omitted) so as to perform a further determination and process.

After the associated information is received from the session manager agent module 430, the RFID tag handler agent module 412 performs a two-phase checking.

Phase 1 checking: the RFID tag handler agent module 412 compares the tag ID, id_type, event content, and other associated parameter information with the associated parameters of the workstation in the database (agent memory) 440, and preliminarily determines whether the events represented by the work piece 400 can be processed in this workstation 410. If yes, it finishes the phase checking and goes to Phase 2 checking. If no, the associated error message is sent.

Phase 2 Checking: Associated information is requested from the event manager agent module 420 through the session manager agent module 430, according to the event content and the associated parameters of the workstation. The event manager agent module 420 reads associated production information (e.g., the processing route information) from the system database (agent recipe) 450 according to the associated parameters, and sends it back to the RFID tag handler agent module 412 through the session manager agent module 430. The RFID tag handler agent module 412 compares the data with the event content read just now and the associated parameters of the workstation, so as to determine whether to process the event or not (whether the process sequence is correct or not). If yes, it informs the service manager agent module 460 and starts to process the event; otherwise, the correct information (such as the correct production routing information) is generated through data comparison and calculation and finally displayed to the user.

When the BOM checking flag of the work piece 400 is set to a process manner of Y (YES), it represents that after the RFID tag handler agent module 412 performs the two-phase checking, it must continue to read the RFID tags of the key components or even the material lot, thereby determining whether the main product is combined with a correct component or uses a correct material quantity. In other words, when the BOM checking flag of the work piece 400 is set as Y (YES), no matter whether the BOM checking flag of the key component or the material lot read subsequently is set as Y (YES) or N (NO), the RFID tag handler agent module 412 of the system obtains the associated Bill of Material (BOM) information from the system database (agent recipe) through the session manager agent module 430 according to the BOM ID of the main product, the key component, or the material lot, and compares the acquired information to determine whether the main product is combined with a correct component or uses the correct material quantity. If no, an associated error message is sent. If yes, the associated information of the key component or the material lot is registered in the RFID tag handler agent module 412 to be processed subsequently.

After that, the RFID tag handler agent module 412 notifies the service manager agent module 460 to process the event, and transmits the associated parameter data so as to perform a further process. The service manager agent module 460, upon receiving an event processing notification and associated parameter data from the tag handler agent, retrieves location and/or operation specific (event process logic or recipe) information cached in session manager agent according the tag ID, location ID, event content, and other associated information in the parameters. Alternately, if detail event data is predefined and preloaded in the Mobile Agent memory bank during tagged object initialization, the service manager agent performs its operation directly according to the associated setting data and instructions of the tag sent from the Tag Handler Agent.

The service manager agent module 460 transmits the event process information to the external system, and drives its automatic process flow (directly drives or communicates with the external system 480 through the network service and SOA architecture) or waits for a manual process. When the external process flow completed, the external processing information is sent back to the service manager agent module 460 by the external system 480 (directly or through the network service and SOA architecture). Then service manager agent module 460 registered these information in the cache memory of session manager module 430. It should be noted that if the event mode of this event is predetermined, the service manager agent module 460 performs its operation directly according to the associated setting data and work instructions of the workstation sent from the RFID tag handler agent module 412.

The service manager agent module 460 informs the RFID tag handler agent module 412 after completing the aforementioned operation, and sends a completion notice and associated parameters to the event manager agent module 420 through the session manager agent module 430.

The event manager agent module 420 reads associated production flow information from the system database (agent recipe) 450 according to the associated parameters, and obtains the latest information of the usage state (fully loaded or idle) of the associated workstation in the system database (agent memory) 440 through the session manager agent module 430. Finally, data comparison and computing is performed according to the information, and the associated information of the event to be completed in the next stage of the work piece 400 (such as, whether the id_type or the process mode needs to be changed, and the location of the next workstation) are obtained, and a new event information (id_type and event content) is generated according to the information. It should be noted that if the event mode of the event is predefined, this step is omitted.

Then, the event manager agent module 420 announces and transmits a new event ID to the RFID tag handler agent module 412. The RFID tag handler agent module 412 writes the new event into RFID tag through RFID Middleware and the RFID reader, and also updates the associated parameters of the old event (e.g., changes the event status from unprocessed status to processed status). Herein, before writing the new event to the work piece 400, the RFID tag handler agent module 412 detects the event linklist structure at first. If there exists a pre-loaded new event with event mode set to Dynamic on the event linklist, the RFID tag handler agent module 412 writes the parameters into the preserved blank fields of this new event one by one. If no pre-loaded new event exists, the RFID tag handler agent module 412 prepares a new event content string and writes it in the event recording area of the work piece 400. Finally, the event mode of the next event following the new event is written into the block of the next event mode of the newly added event. If the event mode status of the next event is unable to be determined in advance, its event mode is set to be Dynamic uniformly. Similarly, if the event mode of the event is predetermined, the steps described in this paragraph are omitted.

After it is written successfully (or when the event mode is Predefined, the service manager agent module 460 informs RFID tag handler agent module 412 after it completes, and transmits the completion notice and associated parameters to the event manager agent module 420 through the session manager agent module 430), the RFID tag handler agent module 412 informs the session manager agent module 430, so as to write the associated data registered in its cache memory respectively into the system database (agent memory) 440 and the tag activity database 470 through the session manager agent module 430.

Finally, the associated information is converted by the ETL program, and the data in the system database (agent memory) 440 and the tag activity database 470 are converged to the table group associated with the operational metadata. At this time, the data in the table group associated with the operational metadata are further provided to various agent modules to be used, or gathered to the database, and provided to an enterprise report generation engine to produce associated business reports.

In summary, the present invention is easily applied to an information system of a flexible, agile production control, and also has a complete and flexible data model deign to integrate RFID technology and enterprise information.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A product managing system using RFID technology, comprising:
an RFID tag set on a product, the RFID tag comprising memory data structure information, wherein the memory data structure information comprises:
a tag ID, being used as a code information of the RFID tag;
an object type and attribute, for recording a class of the product and associated information of a product combination; and
an event content, for recording associated information of a product processing procedure;
an RFID reader, for reading the memory data structure information on the RFID tag; and
a server, for receiving the tag ID, the object type and attribute, and the event content provided by the memory data structure information in the RFID tag set on the product from the RFID reader, and achieving a purpose of product management according to a system database and a process setting.

2. The product managing system using RFID technology as claimed in claim 1, wherein the tag ID is product information about product manufacture, product class, product serial number, and the coding manner follows the industry standard or is defined by the company.

3. The product managing system using RFID technology as claimed in claim 1, wherein the object type and attribute are a product category and a product BOM ID, so as to determine a class of the product and determine whether the product is correctly combined with another product.

4. The product managing system using RFID technology as claimed in claim 1, wherein the object type and attribute is information about an agent type, a BOM Checking Flag, and a BOM ID.

5. The product managing system using RFID technology as claimed in claim 1, wherein the event content comprises an event header EH and an event payload EP.

6. The product managing system using RFID technology as claimed in claim 5, wherein the event header is used to record an operational flow of the process sequence, process result, and process mode of the event and determination manners of the event and a next event.

7. The product managing system using RFID technology as claimed in claim 5, wherein the event payload is used to record the event ID and provide a storage space for various setting data which is divided into a preload block and a write block.

8. The product managing system using RFID technology as claimed in claim 5, wherein the event content is increased or decreased dynamically, and the different event contents compose an Event Linklist.

9. The product managing system using RFID technology as claimed in claim 1, wherein the RFID tag is an active RFID tag or a positive RFID tag.

10. The product managing system using RFID technology as claimed in claim 1, wherein the server comprises:
an RFID Middleware module, for reading the tag ID, the object type and attribute, and the event content from the RFID reader;
a central agent module, coupled to the RFID Middleware module to obtain the tag ID, the object type and attribute, and the event content, and determine a processing procedure to be performed according to the obtained data; and
an interface agent module, coupled to the central agent module to receive an external instruction, and transmit the external instruction to the central agent module so as to perform a corresponding processing procedure.

11. The product managing system using RFID technology as claimed in claim 9, wherein the central agent module comprises:
an information agent module, coupled to a database to provide a function of accessing the data or a continuous monitor to the data source;
more than one operation agent modules, coupled to the interface agent module and the information agent module, for receiving an external instruction from the interface agent module and performing a specific processing procedure, and obtaining a required data through the information agent module; and
a coordination agent module, for coordinating and managing an interaction between individual agent modules and continuously monitoring operations of individual agent modules.

12. The product managing system using RFID technology as claimed in claim 9, further comprising:
a database, for storing initial data, master data, static information, dynamic information, process-associated information, RFID tag passage information, and data of an external system to be processed; and
a data managing module, coupled between the database and the server, responsible for accessing the data of the database and converting the data format between the database and the server.

13. A product managing method using RFID technology, the method comprising:
using an RFID tag to provide a tag ID, an object type and attribute, and an event content;
reading the tag ID to determine a product ID of the product;
reading the object type and attribute to determine a class of the product and determine whether the product is correctly combined with another product;
reading the event content to determine whether or not a processing procedure of the product is correct; and
determining whether the product disposed with the RFID tag is normal according to the aforementioned determinations.

14. The product managing method using RFID technology as claimed in claim 13, wherein the provided object type and attribute comprises:
an agent type, for providing a product category;
a BOM Checking Flag, for marking whether or not the product is combined with another product; and
a BOM ID, for marking the product ID of another product combined with the product.

15. The product managing method using RFID technology as claimed in claim 13, wherein when the object type and attribute are read to determine a class of the product and determine whether the product is correctly combined with another product, it is determined whether the product is correctly combined with another product in the case that the BOM Checking Flag marks that the product is combined with another product.

16. The product managing method using RFID technology as claimed in claim 13, wherein the event recording area comprises at least one event content, each of the event content comprising:
an event payload, for recording the event ID of the event and providing a storage space of various setting data; and
an event header, for recording the process sequence, process result, and process mode of the event, and the determination manners of the event and the next event.

17. The product managing method using RFID technology as claimed in claim 15, further comprising:
performing an initialization before the RFID tag is read, and in the initialization, storing the setting data required by the process in the storage space of various setting data provided by the event payload.

18. The product managing method using RFID technology as claimed in claim 15, further comprising:
after each event is processed, recording the associated information produced during the processing into the storage space of various setting data provided by the event payload.

19. The product managing method using RFID technology as claimed in claim 15, further comprising:
before RFID is read, performing an initialization to reset the content of the RFID tag.

20. The product managing method using RFID technology as claimed in claim 17, wherein the step of performing initialization comprises:
resetting the RFID tag;
obtaining the initial data of the external system;
collating and storing the initial data into a corresponding data table of the database;
obtaining the tag ID and the object type and attribute according to the data in the corresponding data table;
defining the event content; and
writing the tag ID, the object type and attribute, and the event content into the RFID tag.

21. The product managing method using RFID technology as claimed in claim 19, wherein the step of resetting the event content comprises:
setting the determination manner of the event as Predefined (PD);
setting the field of a flag determining whether the event payload is allowed to record as ON, and preparing the setting data in the field used when writing the event payload; and
determining the determination manner of the next event.

22. The product managing method using RFID technology as claimed in claim 20, wherein the step of resetting the event content comprises:
setting the determination manner of the event as Dynamic (DY);
setting the field of a flag determining whether or not the event payload is allowed to record as ON, and clearing the unset data fields; and
determining a determination manner of the next event.

23. A product managing method using RFID technology, comprising steps of processing an RFID tagged work piece entering a workstation equipped with an RFID reader/reader group, wherein the steps of processing the RFID tagged work piece comprise:
an RFID tag handler agent module's fetching a next available tag data through an RFID middleware module;
the RFID tag handler agent module's parsing and analyzing a tag ID and an event string to obtain associated parameters and pass relevant parameters to a session manager agent module;
a session manager agent's obtaining the associated information with a certain mobile agent and location and/or operation specific information from a system database using the relevant parameters just passed from the RFID tag handler agent module and then caching these data in its memory;
the session manager agent's sending key parameters regarding a certain mobile agent back to the RFID tag handler agent so as to perform a further determination and process;
a tag handler agent's comparing the tag ID and event parameters with the associated parameters provided by the session manager agent, so as to determine whether the event represented by a mobile agent can be processed at this location and at this time, if yes, the RFID tag handler agent module sending a notification with associated parameter data to a service manager agent module to process the event; otherwise, the RFID tag handler agent module informing the service manager agent module to handle the exception and to display an error message and relevant correcting information to a user;
upon receiving an event processing notification and associated parameter data from the RFID tag handler agent module, a service manager agent module's retrieving location and/or operation specific information cached in the session manager agent module according the tag ID, a location ID, an event ID, and other associated information in the parameters, wherein, if detail event data is predefined and preloaded in a Mobile Agent memory bank during tagged object initialization, the service manager agent performs its operation directly according to the associated setting data and instructions of the tag sent from the RFID tag handler agent module;
the service manager agent module's transmitting the event process logic or recipe information to the external system, and driving its automatic process flow, wherein, when the external process flow completed, the external processing information is sent back to the service manager agent module by the external system and then service manager agent module relays these information to the session manager agent module;
a session manager agent module's registering external processing information in its cache memory and sending a completion notice and associated parameters to an event manager agent module for further process;
the event manager agent module's obtaining production routing and recipe information regarding the work piece from the system database, performing data comparison and computing to determine a next stage of the mobile agent and generate a new event information, and finally instructing the RFID tag handler agent module to write the new event to the tagged work piece;
the RFID tag handler agent module's writing the new event into the mobile agent and updating the associated parameters of the current event while the RFID tag handler agent module notifies the session manager agent module about the completion of this production event cycle; and
the session manager agent module's storing associated production event handling data registered in its cache memory respectively into the system database and a tag activity database and releasing from its cache memory corresponding cached event data regarding the work piece during this event handling session.
